(19) United States
(12) Patent Application Publication
(10) Pub. No.: US 2020/0305651 A1
(43) Pub. Date: Oct. 1, 2020

(54) AFFIXABLE POUCH

(71) Applicant: Suzanne S. MAYS-HORNUNG, Cockeysville, MD (US)

(72) Inventor: Suzanne S. MAYS-HORNUNG, Cockeysville, MD (US)

(21) Appl. No.: 16/833,423

(22) Filed: Mar. 27, 2020

Related U.S. Application Data
(60) Provisional application No. 62/824,836, filed on Mar. 27, 2019.

(51) Int. Cl. A47J 47/16; F16B 47/00; F16M 13/02

(52) U.S. Cl. CPC A47J 47/16; F16M 13/02; F16B 47/003

(57) ABSTRACT

A pouch comprising first and second rectangular pieces of a first material attached to each other along at a portion of at least three sides to form a first pouch. The pouch further comprises a fastener attached to a first outer side of the first rectangular piece, a fastener attached to a first outer side of the second rectangular piece, and a second pouch of a second material attached inside the first pouch. The second pouch having an opening aligned with at least a portion of an opening of the first pouch and for receiving an item inside.

### PRIORITY

The present application claims priority from U.S. Prov. Pat. Appl. No. 62/824,836, filed Mar. 27, 2019, the contents of which are hereby incorporated, in their entirety, by reference.

### BACKGROUND

The present invention relates to a “smart” affixed ring pouch that is ready to be used while doing various tasks including, but not limited to, doing the dishes, washing hands, and cleaning or preparing food. The ring pouch is readily and easily accessible, may affixed to any convenient or designated location/area, has a pleasing look, frees up counter space, is easy to use, is constructed from one or more materials that is/are kitchen friendly, and/or are constructed or formulated to provide wicking and/or antimicrobial material properties. The ring pouch, once mounted in a safe and convenient place, is available for the consumer to use over and over again.

The present invention also relates to a “smart” affixed audio accessory pouch suitable for the temporary storage of hearing aids, wireless headphones, Bluetooth® earbuds, or phone earpiece(s) that is ready to be used when a consumer needs a place to store their hearing aids or phone earpieces after removing them from their ears. Hearing aids, particularly the smaller in-ear models are small and easily misplaced and/or damaged, particularly as memory fades, without a dedicated place in which to store the hearing aids. Similarly, it is not an infrequent occurrence that a hearing aid user neglects to remove them before swimming, showering, or bathing, thereby risking serious damage to the devices. Again, a dedicated storage place adjacent the shower, bath, or pool enclosure will reduce the likelihood of inadvertent water damage. The audio accessory pouch is readily and easily accessible, may affixed to any convenient or designated location/area, has a pleasing look, frees up counter space, is easy to use, is constructed from one or more materials that is/are kitchen friendly and/or include an antimicrobial material. The audio accessory pouch, once mounted in a safe and convenient place, e.g., on a bathroom mirror, a nightstand, or a recliner, is available for the consumer to use over and over again. One or more embodiments according to the present disclosure relates to an audio accessory pouch which is convenient, sterile, safe, and secure for the temporary placement of small audio accessories including, for example, hearing aids, earbuds, and/or other small earpieces.

Although many people routinely wear rings and other jewelry on their fingers and wrists, many daily activities are complicated by the presence of such jewelry. This is particularly true in the kitchen in which the jewelry may be damaged, soiled, and/or lost during the preparation of a meal or the subsequent cleanup. Indeed, many p-traps and disposals have been disassembled in the frantic search for a valuable or sentimental ring that has been lost or misplaced. Even experienced cooks routinely deal with this issue including, for example, Rachel Ray, who has stated publicly that she was always losing her wedding ring when she took it off in the kitchen while she was cooking.

In kitchen applications, the ring pouch detailed below can be located on a wall, a backsplash above the kitchen counter/sink area, a window casing, a cabinet side panel, a cabinet door (inside or outside), or any other safe and convenient location. Similarly, in bathroom applications, the ring pouch can be located on a wall, a backsplash above the bathroom counter/sink area, a mirror, a cabinet side panel, a cabinet door or drawer (inside or outside), or any other safe and convenient location. Indeed, the ring pouch can be placed in almost any location where the consumer feels comfortable temporarily placing the ring(s) or other jewelry while completing the jewelry-unfriendly activity, only to retrieve the rings or other jewelry from the conveniently located ring pouch.

The commercially available small item storage products simply do not provide all of the desired functionality. For example, other ring pouches, while sometimes attractive, do not provide a means for securing the pouches in a convenient location. Some other ring pouches do not have fast, “easy access” capability that would allow quick, one-handed, deposit and retrieval of the ring(s) or other items. Other ring pouches do not tend to be manufactured from materials that are suitable for wet conditions such as those found in a kitchen or bathroom. Other ring pouches do not tend to be manufactured from materials that are easily cleaned when soiled during normal use. Other ring pouches are configured to simply be placed on top of a surface, making them more susceptible to unintended movement, damage, soiling, and loss, and generally adding unwanted clutter on the respective surfaces. Other ring pouches are not designed for easy attachment at a preferred or designated location that would prevent unintended movement, damage, soiling, and loss. Some ring pouches, for example, use a suction cup attachment which significantly limits the number of household surfaces on which they can be mounted. Other ring pouches are readily moved and, as a result, will not reinforce the routine and/or habitual use of the ring pouch to secure rings or other small items.

Accordingly, an unsatisfied need exists for a product that can be utilized by the wearers of rings and/or other jewelry, for keeping the jewelry safe and dry as the owners engage in jewelry-unfriendly activities including, for example, preparing food, washing hands, general cleaning, and/or washing the dishes. Similarly, an unsatisfied need exists for a product that can be utilized by persons who routinely utilize hearing aids, ear buds, and/or other small earpieces, for keeping these small and important personal electronics safe, convenient, and readily accessible while the owners engage in other activities for which the hearing aids, ear buds, and/or other small earpieces are not required or desired.

It is therefore an object of one or more embodiments according to the present disclosure to provide a ring pouch/accessory pouch that addresses the noted limitations of the conventional ring pouches/accessory pouches, can be temporarily, removably, or permanently affixed in an area convenient to consumer is aesthetically pleasing, is manufactured from one or more kitchen/earpiece friendly material(s), and/or provides both secure storage and easy accessibility.

### BRIEF DESCRIPTION OF THE DRAWINGS

Aspects of the present disclosure are best understood from the following detailed description when read in conjunction with the accompanying figures. It is noted that, in accordance with the standard practice in the industry, various features are not drawn to scale. In fact, the dimensions of the various features may be arbitrarily increased or reduced for clarity of discussion.

FIGS. 1-12 are a series of plan and side views of a pouch, in accordance with a first embodiment.

FIGS. 13-23 are a series of plan and side views of a pouch, in accordance with a second embodiment.

FIGS. 24-26 are plan views of fastener systems suitable for use in accordance with various embodiments.

FIGS. 27-36 are plan views of a pouch, in accordance with a third embodiment.

FIGS. 37-43 are plan views of a pouch, in accordance with a fourth embodiment.

FIGS. 44-48 are plan views of a pouch, in accordance with a fifth embodiment.

FIGS. 49-53 are plan views of a pouch, in accordance with a sixth embodiment.

### DETAILED DESCRIPTION

The following disclosure provides many different embodiments, or examples, for implementing different features of the subject matter disclosed below. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90° or at other angular orientations) and the spatially relative descriptors used herein may likewise be interpreted accordingly.

The disclosed ring pouch (hereinafter “ring pouch”) is designed for repeated use during normal daily activities which are conducted at the same location. The ring pouch will typically be affixed to convenient location, e.g., a wall, a backsplash above the kitchen counter/sink area, a window casing, a cabinet side panel, a cabinet door (inside or outside), a drawer (inside or outside), or any other safe and convenient location. As a result of the fixed location, using the ring pouch will entail the essentially the same motions in the same location each time, thereby tending to make its use more automatic or habitual. As a result, the ring pouch will tend to be used more routinely or frequently, thereby enabling the user to save time, effort, and energy. Having the ring pouch in the same location everyday enables the ring wearer a safe, consistent location to place their ring(s), so that they are able to continue with only the briefest interruption, to their jewelry-unfriendly tasks, including, but not limited to, meal preparation, hand washing, cleaning, and/or washing the waiting dishes.

As detailed below, the disclosed ring pouch has an open top for fast, “easy access” suitable for one-handed operation that does not require the fastening or unfastening of clasps, snaps, or other fasteners for access to the interior storage recess of the ring pouch. Some embodiments of the ring pouch can be attached, mounted, or affixed horizontally, partially inclined, or vertically wherever needed including, but not limited to, a kitchen counter backsplash, the wall outside a shower, a mirror, or any other surface convenient for the consumer. Once affixed to the chosen surface, the ring pouch will tend to eliminate, or at least significantly reduce, the likelihood of damage to, misplacement of, or the loss of the ring pouch contents and reduces clutter on nearby surfaces. The ring pouch is manufactured from materials that are both attractive (and even decorative) and suitable for use in the kitchen, bath, or gym and may include for example, antimicrobial and/or wicking fibers and materials that will tend to suppress bacterial growth and/or excess moisture. Some embodiments of the ring pouch will include only materials suitable for machine washing.

Some embodiments of the ring pouch include a main body that is made of a soft, flexible, and porous polymeric material configured to provide a recess, the recess being sized to receive the ring(s) or other suitably sized items. In some embodiments, the recess includes a lining comprising a layer of an antimicrobial material. The lining maybe attached to the inner surface main body by stitching, serging, gluing, laminating, plastic welding, hook and loop material, or other suitable attachment methods. In some embodiments, the main body is constructed from a laminar fabric material that includes at least a first layer of porous polymeric material and a second layer of an antimicrobial material. In some embodiments, the polymeric material and the antimicrobial material comprise woven materials, non-woven materials, and/or films which, in some embodiments also incorporate reinforcing fibers or other functional additives, including, for example, conductive material that improves the material's ability to dissipate electrical charges and thereby suppress electrostatic discharges (ESD) that could damage electronic components contained within the ring pouch.

As used herein, antimicrobial material refers to materials that include antimicrobial fibers to which antimicrobial agents have been added, either by applying an antimicrobial agent with a surface treatments or by being incorporated and antimicrobial agent, polymer, or compound within the fiber body. Antimicrobial additives can be added to the fibers during formulation, spinning, or extrusion operations, combined with dyes or pigments introduced into the bulk fiber material, or applied to the fiber or fabric surface as a finishing process. The specific method used to impart the desired antimicrobial functionality into the fiber is determined by a variety of factors including the intended final use of the fabric, the capability of the fabric manufacturer, target product price point, and/or the buyer's budget.

Antimicrobial materials are useful in manufacturing embodiments of the ring pouch because the relatively large surface area and moisture retention found in most fabrics tends to encourage microbial growth. This microbial growth can lead to unpleasant effects for both the material and the consumer including reduced textile, stains, and/or unpleasant odors. Antimicrobial polymers are able to inhibit the growth of microorganisms such as bacteria, fungi, and/or protozoans, typically by mimicking antimicrobial peptides used in mammalian immune systems for killing or suppressing invading microorganisms.

In addition to the use of antimicrobial materials, some embodiments of the ring pouch utilize one or more moisture-wicking fabrics. Moisture-wicking fabrics are capable of moving moisture away from a fabric's interior surface having a higher moisture content to a lower moisture content at the fabric's outer surface where the moisture can evaporate more easily. Moisture-wicking fabrics are typically soft, lightweight, and have some stretch, qualities that are useful in the manufacture of the ring pouches for helping to control the level of moisture within the recess and further suppress any microbial activity. In some embodiments, moisture-wicking fabrics may be formulated and configured to provide a drywicking functionality in which a two-layer fabric structure reduces the surface tension of interior water and propels the water through a hydrophobic first layer, into a natural wicking second layer, and eventually to an outer surface where the moisture can evaporate.

Depending on the material(s) selected for manufacturing the ring pouches, in some embodiments the material used for constructing the main body can have enough stretch/elasticity to remain closed until the consumer inserts their fingers through the opening in order to deposit or retrieve the rings or other items. In other embodiments, utilizing a non-elastic or insufficiently elastic material, a section of an elastomeric material is provided around at least a portion of the pouch opening to provide a degree of tension sufficient to maintain the pouch in a normally closed configuration.

In other embodiments, a fastener is provided at the pouch opening for securing the pouch in a closed or partially closed configuration. Depending on the size, intended use, styling, and material(s) used in the ring pouch, suitable fasteners for securing the opening of the pouch include, but are not limited to, snaps/press studs, hook and loop material, hook and eye closures, magnetic fasteners, frog fasteners, and toggle fasteners. In other embodiments, no fastener or fastening system is provided at the pouch opening, thereby allowing the pouch opening to assume a degree of openness determined by the construction, material, orientation, and/or contents.

Other embodiments of the ring pouch will include a fastener or fastener system provided on a back surface for affixing the ring pouch to a designated mounting surface. Depending on the size, intended use, styling, and material(s) used, suitable fasteners for securing the ring pouch to a mounting surface include, but are not limited to, two-sided adhesive strips, hook and loop material, loop and hook fasteners, magnetic fasteners, plastic or metal clips, z-clips, snap fits, slide fits, screws, plastic locking strips (e.g., 3M Dual Lock™ strips), or other suitable mechanical fasteners.

In some embodiments, a first portion of a fastener system is attached to a rear surface of the ring pouch and a second portion of the fastener system is attached to the mounting surface. In order to mount the ring pouch on the mounting surface, the first portion of the fastener system is engaged with the corresponding structures on the second portion of the fastener system. Embodiments of the ring pouch preferably include fasteners and/or fastening systems that provide a secure but removable attachment so that the ring pouch can be easily relocated as desired by the user and without damage to the mounting surface. Some embodiments incorporate a removable adhesive strip, e.g., a Command™ strip, either alone or in combination with another fastening means, whereby the ring pouch can be easily mounted, removed, and remounted in a different location without damaging the mounting surface.

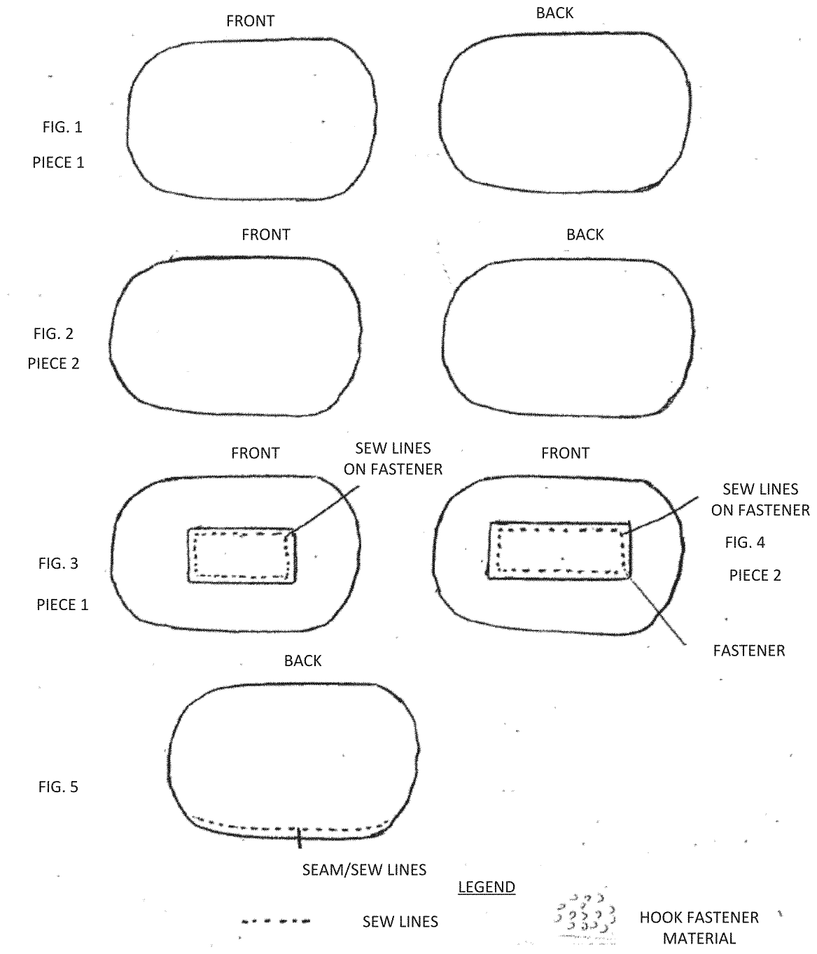

A first embodiment of the ring pouch includes, as shown in FIG. 1, Piece 1 comprising a section of a soft, porous plastic material that is elongated, generally rectangular in shape with rounded corners and having a Front side and a Back side and four edges, as shown in FIG. 2, Piece 2 comprising another section of soft, porous plastic that is elongated and rectangular in shape with curved corners and has Front and Back sides and four edges, and is equivalent in size to Piece 1. In an alternative construction, the Piece 1 and Piece 2 sections are combined into a single section (see the configuration of the liner shown in FIG. 6), thereby eliminating the need for a separate operation or step to join the two Pieces later in the manufacturing process.

As shown in FIG. 3, a piece of hook and loop sew-on fastener (that, depending on the size and configuration of Piece 1, generally ranges from about 0.25 to 4 inches in length and about 0.25 to 3 inches in height) is attached lengthwise (horizontally) onto the Front side about the center area of Piece 1. The hook portion of the hook and loop fastener can be removably attached to the corresponding loop portion of the hook and loop fastener. Hook and loop sew-on, hook and loop tape, and other attachment means are readily available and can be used as a suitable attachment means throughout the different embodiments of the ring pouch.

As shown in FIG. 4, a piece of hook and loop sew-on fastener (that, depending on the size and configuration of Piece 2, generally ranges from about 0.64 to 10 cm in length and about 0.64 to 7.6 cm in height) is attached lengthwise (horizontally) onto the Front side about the center area of Piece 2. The hook portion of the hook and loop fastener can be removably attached to the corresponding loop portion of the hook and loop fastener. In some embodiments, the size of the piece of hook and loop sew-on fastener provided on Piece 2 (Front) will be up to 2 inches longer than the piece of hook and loop sew-on fastener provided on Piece 1 (Front).

As shown in FIG. 5, Piece 1 and Piece 2 are stacked with their edges aligned and with the respective Back sides facing each other (inside). Piece 1 and Piece 2 are then joined by, for example, sewing close to the elongated edge forming a seam along the bottom. Once joined, the combination Piece 3 can be opened with the seam facing down as shown in FIG. 6. A piece of antimicrobial material having a profile similar to, but slightly smaller than, the combination Piece 3 (the edge of the antimicrobial material will be offset by up to 2 cm from the edge of the combination Piece 3) and aligned with the combination Piece 3. The antimicrobial material can then be attached by, e.g., sewing, to the combination Piece 3 to form a liner.

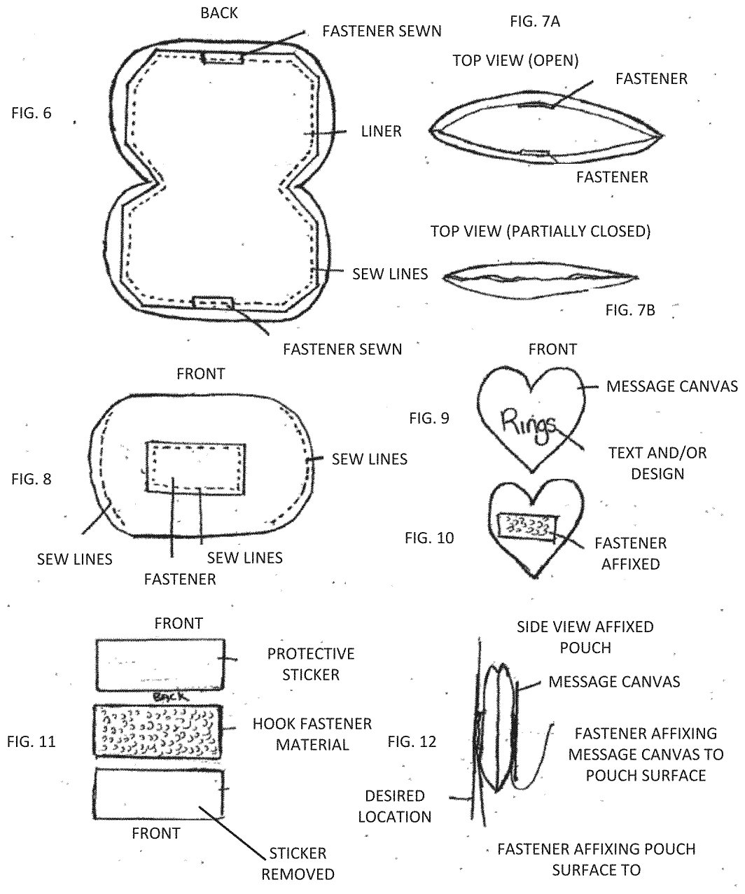

As shown in FIGS. 6, 7A and 7B, in some embodiments, two small pieces of a fastener can be attached to the liner's short edges, typically centered and in the range of 0.25 to 3 centimeters from the edge of the liner. The addition of the two small pieces of a fastener can be done in conjunctions with sewing the liner onto the combination Piece 3 with the actual sequence being dictated or determined by the manufacturer and/or seamstress for efficient manufacturing operations.

The combination Piece 3 can then be closed or folded to return to the original profile of individual Pieces 1 and 2 with the liner now forming an interior surface. As the combination Piece 3 are folded, the two small pieces of a fastener are provided on opposite sides of the opening, as shown in FIG. 7A, and, when brought into contact, the two small pieces of a fastener engage to form a partial closure of the opening, as shown in FIG. 7B. The short length sides of the combination Piece 3 can then be joined by, for example, sewing, adjacent the outer edge to form a seam on both sides that, in combination with the previous seam along the bottom, completes a lined ring pouch as shown in FIG. 8.

As shown in FIGS. 9 and 10, some embodiments include a message canvas that has a Front and a Back side. The message canvas can be any shape but will typically not exceed the dimensions of the ring pouch to which it will be applied. In this example, the “heart” shape of the message campus is provided only as an example and is not intended to limit the configuration(s) of message canvas that can be utilized in connection with the ring pouch. In some embodiments, a message, saying, word, and/or decorative element(s) is provided on the front of the message canvas.

In some embodiments, the message canvas will comprise a piece of fabric and at least one corresponding piece of a polymer film (not shown). The fabric and the polymer film are laminated by, for example, gluing or heat sealing to form a bond between the two materials and thereby improve the fabric strength and reduce fraying at the edges of the message canvas. Some embodiments utilize a thermoplastic polyurethane (TPU) is a flexible film that exhibits high elongation and other properties and characteristics including, for example, dynamic flex performance, abrasion resistance, and tear strength that are generally superior to most other polyolefinic films.

In some embodiments, a clear polymer film (not shown) may be provided on the front surface of the message canvas to provide additional protection from moisture, other contaminants, and/or physical damage to the decorative elements provided on the message canvas. In some embodiments, the message, saying, word, design, image, and/or other decorative element(s) are applied to the Front side of the message canvas using, for example, inks, dyes, paint, thread, floss, appliques, or any other suitable media using one or more techniques including, for example, painting, dyeing, silk screening, embroidery, stamping, and/or stenciling.

As shown in FIG. 10, in some embodiments, a fastener or a portion of a fastener system is applied to the back of the message canvas. The sizing of the fastener or portion of the fastener system will generally correspond to the fastener or corresponding portion of the fastener system provided on the front surface of the ring pouch as shown in FIG. 8. An example of a fastener system is shown in FIG. 11 in which to portions of a hook and loop fastener are provided protective stickers preventing premature attachment of the two portions of the fastener system.

In some embodiments, the protective sticker is removed from a first portion of the hook and loop fastener system, thereby exposing an adhesive film by which the first portion is attached to the back side of the message canvas, leaving exposed a section of hook and loop material. Similarly, in some embodiments, the protective sticker is removed from a second portion of the hook and loop fastener system, thereby exposing an adhesive film by which the second portion is attached to the front side of the ring pouch. In other embodiments, the second portion of the hook and loop fastener system is already provided on the front side of the ring pouch, having been sewn into place or otherwise attached to the front side of the ring pouch during the manufacturing process. The exposed hook and loop fasteners on the first and second portions are then pressed together to attach the message canvas to the ring pouch as shown in FIG. 12. The message canvas is appealing to the consumer and may dictate or suggest the manner in which the ring pouch is to be used.

In some embodiments, the protective sticker is removed from a first portion of the hook and loop fastener system, thereby exposing an adhesive film by which the first portion is attached to the mounting surface, leaving exposed a section of hook and loop material. Similarly, in some embodiments, the protective sticker is removed from a second portion of the hook and loop fastener system, thereby exposing an adhesive film by which the second portion is attached to the back side of the ring pouch. In other embodiments, the second portion of the hook and loop fastener system is already provided on the back side of the ring pouch, having been sewn into place or otherwise attached to the front side of the ring pouch during the manufacturing process. The exposed hook and loop fasteners on the first and second portions are then pressed together to attach the ring pouch to the mounting surface as shown in FIG. 12.

In some embodiments particularly suited to travel, the ring pouch packaging includes a piece of Command™ adhesive with, for example, hook and loop, magnetic, or Dual Lock™ fastener material provided opposite the adhesive that is about 0.64 to 10 cm in length and about 0.64 to 7.6 cm in height. The Front side has a protective sticker covering an adhesive strip and the Back side has exposed loop/hook, magnetic, or Dual Lock™ surfaces. In order to mount the ring pouch, the consumer will remove the protective sticker from the Back of the first portion of the fastener system and affix this first portion to the desired location. Similarly, in some embodiments, the protective sticker is removed from a second portion of the fastener system, thereby exposing an adhesive film by which the second portion is attached to the back side of the ring pouch. In other embodiments, the second portion of the fastener system is already provided on the back side of the ring pouch, having been sewn into place or otherwise attached to the front side of the ring pouch during the manufacturing process. The complementary surfaces of the first and second portions are then pressed together to attach the ring pouch to the mounting surface as shown in FIG. 12.

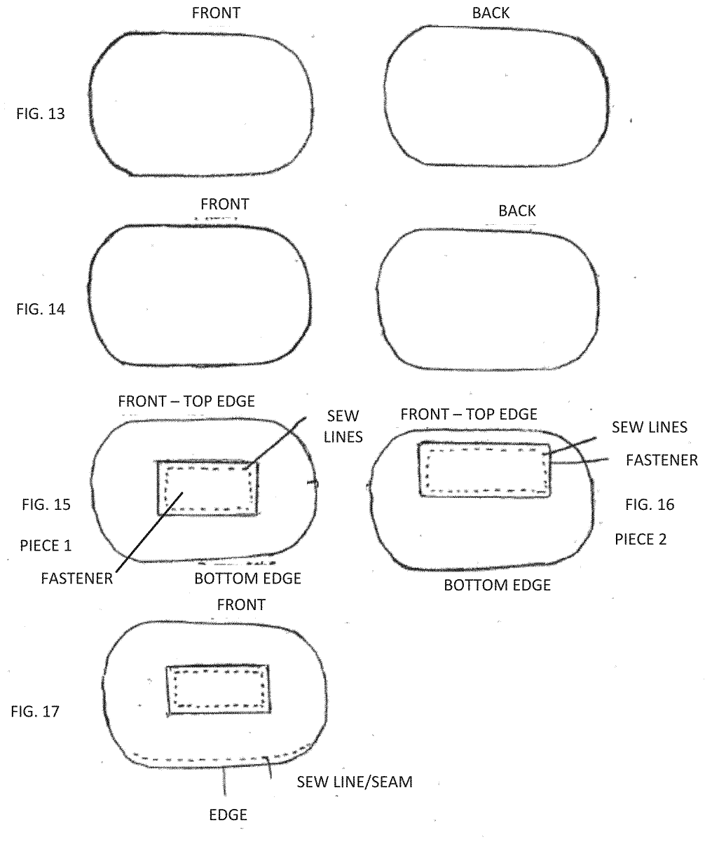

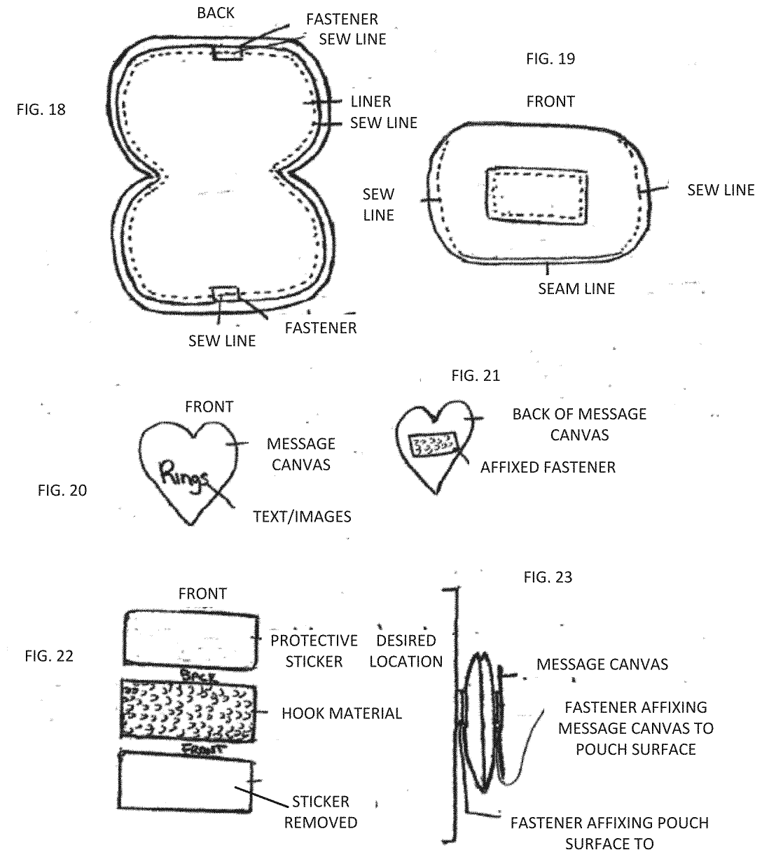

A second embodiment of the ring pouch includes, as shown in FIG. 13, Piece 1 comprising a section of a soft, porous plastic material that is elongated, generally rectangular in shape with rounded corners and having a Front side and a Back side and four edges, as shown in FIG. 14, Piece 2 comprising another section of soft, porous plastic that is elongated and rectangular in shape with curved corners and has Front and Back sides and four edges, and is equivalent in size to Piece 1. In an alternative construction, the Piece 1 and Piece 2 sections are combined into a single section (similar to the configuration of the liner shown in FIG. 18), thereby eliminating the need to join the two Pieces later in the manufacturing process.

As shown in FIG. 15, a piece of hook and loop sew-on fastener (that, depending on the size and configuration of Piece 1, generally ranges from about 0.25 to 4 inches in length and about 0.25 to 3 inches in height) is attached lengthwise (horizontally) onto the Front side about the center area of Piece 1. The hook portion of the hook and loop fastener can be removably attached to the corresponding loop portion of the hook and loop fastener. Hook and loop sew-on, hook and loop tape, and other attachment means are readily available and can be used as a suitable attachment means throughout the different embodiments of the ring pouch.

As shown in FIG. 16, a piece of hook and loop sew-on fastener (that, depending on the size and configuration of Piece 2, generally ranges from about 0.64 to 10 cm in length and about 0.64 to 7.6 cm in height) is attached lengthwise (horizontally) onto the Front side and centered in the top ⅕ to ⅓ of Piece 2. As will be appreciated by those skilled in the art, the placement of the fastener elements is not limited and may include one or more fastener elements arrayed in varying orientations across the back surface of the ring pouch. The hook portion of the hook and loop fastener can be removably attached to the corresponding loop portion of the hook and loop fastener. In some embodiments, the size of the piece of hook and loop sew-on fastener provided on Piece 2 (Front) will be up to 5 cm longer than the piece of hook and loop sew-on fastener provided on Piece 1 (Front).

As shown in FIG. 17, Piece 1 and Piece 2 are stacked with their edges aligned and with the respective Back sides facing each other (inside). Piece 1 and Piece 2 are then joined by, for example, sewing close to the elongated edge forming a seam along the bottom. Once joined, the combination Piece 3 can be opened with the seam facing down as shown in FIG. 18. A piece of antimicrobial material having a profile similar to, but slightly smaller than, the combination Piece 3 (the edge of the antimicrobial material will be offset by up to 2 cm from the edge of the combination Piece 3) and aligned with the combination Piece 3. The antimicrobial material can then be attached by, e.g., sewing, to the combination Piece 3 to form a liner.

As shown in FIG. 18, in some embodiments, two small pieces of a fastener can be attached to the liner's short edges, typically centered and in the range of 0.25 to 3 centimeters from the edge of the liner. The addition of the two small pieces of a fastener can be done in conjunctions with sewing the liner onto the combination Piece 3 with the actual sequence being dictated or determined by the manufacturer and/or seamstress for efficient manufacturing operations.

The combination Piece 3 can then be closed or folded to return to the original profile of individual Pieces 1 and 2 with the liner now forming an interior surface. The short length sides of the combination Piece 3 can then be joined by, for example, sewing, adjacent the outer edge to form a seam on both sides that, in combination with the previous seam along the bottom, completes a lined ring pouch as shown in FIG. 19.

As shown in FIGS. 20 and 21, some embodiments include a message canvas that has a Front and a Back side. The message canvas can be any shape but will typically not exceed the dimensions of the ring pouch to which it will be applied. In this example, the “heart” shape of the message campus is provided only as an example and is not intended to limit the configuration(s) of message canvas that can be utilized in connection with the ring pouch. In some embodiments, a message, saying, word, and/or decorative element(s) is provided on the front of the message canvas.

In some embodiments, the message canvas will comprise a piece of fabric and at least one corresponding piece of a polymer film (not shown). The fabric and the polymer film are laminated by, for example, gluing or heat sealing to form a bond between the two materials and thereby improve the fabric strength and reduce fraying at the edges of the message canvas.

In some embodiments, a clear polymer film (not shown) may be provided on the front surface of the message canvas to provide additional protection from moisture, other contaminants, and/or physical damage to the decorative elements provided on the message canvas. In some embodiments, the message, comprising word(s), saying(s), design(s), image(s), and/or other decorative element(s) are applied to the Front side of the message canvas using, for example, inks, dyes, paint, thread, floss, appliques, or any other suitable media using one or more techniques including, for example, painting, dyeing, silk screening, embroidery, stamping, and/or stenciling.

As shown in FIG. 21, in some embodiments, a fastener or a portion of a fastener system is applied to the back of the message canvas. The sizing of the fastener or portion of the fastener system will generally correspond to the fastener or corresponding portion of the fastener system provided on the front surface of the ring pouch as shown in FIG. 19. An example of a fastener system is shown in FIG. 22 in which to portions of a hook and loop fastener are provided with protective stickers for preventing premature exposure of the adhesive surface and/or inadvertent attachment of one or both of the two portions of the fastener system in an undesired location.

In some embodiments, the protective sticker is removed from a first portion of the hook and loop fastener system, thereby exposing an adhesive film by which the first portion is attached to the back side of the message canvas. Similarly, the protective sticker is removed from a second portion of the hook and loop fastener system, thereby exposing an adhesive film by which the second portion is attached to the front side of the ring pouch. In other embodiments, the second portion of the fastener system is already provided on the front side of the ring pouch. The exposed hook and loop fasteners on the first and second portions are then pressed together to attach the message canvas to the ring pouch as shown in FIG. 23. The message canvas is appealing to the consumer and may dictate or suggest the manner in which the ring pouch is to be used or the intended contents, e.g., rings, an “ear” graphic, etc.

In some embodiments, the protective sticker is removed from a first portion of the hook and loop fastener system, thereby exposing an adhesive film by which the first portion is attached to the mounting surface. Similarly, the protective sticker is removed from a second portion of the hook and loop fastener system, thereby exposing an adhesive film by which the second portion is attached to the back side of the ring pouch. In other embodiments, the second portion of the fastener system is already provided on the back side of the ring pouch, having been sewn into place or otherwise attached to the front side of the ring pouch during the manufacturing process. The exposed hook and loop fasteners, or other suitable fasteners or fastener systems, provided on the first and second portions are then pressed together to attach the ring pouch to the mounting surface as shown in FIG. 23.

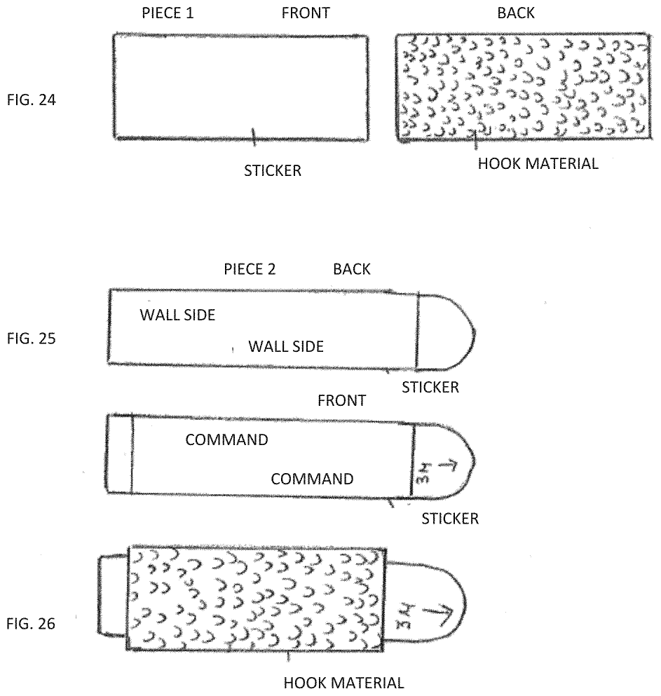

In some embodiments particularly suited to travel, the ring pouch packaging includes a piece of Command™ adhesive as shown in FIG. 24 with, for example, hook and loop, magnetic, or Dual Lock™ fastener material provided opposite the adhesive that is about 0.64 to 10 cm in length and about 0.64 to 7.6 cm in height. The Front side has a protective sticker covering an adhesive strip and the Back side has exposed loop/hook, magnetic, or Dual Lock™ surfaces. As shown in FIGS. 25-26, in order to mount the ring pouch, the consumer will remove the protective sticker from the Back of the first portion of the fastener system and affix this first portion to the desired location. Similarly, the protective sticker is removed from a second portion of the fastener system, thereby exposing an adhesive film by which the second portion is attached to the back side of the ring pouch. In other embodiments, the second portion of the fastener system is already provided on the back side of the ring pouch. The complementary surfaces of the first and second portions are then pressed together to attach the ring pouch to the mounting surface as shown in FIG. 23.

According to some embodiments, the basic ring pouch is configured for storing eyeglasses, goggles, and/or sunglasses are storable, by increasing the length and/or width of the ring pouch to accommodate the larger dimensions of folded eyeglasses, e.g., about 2.5 to 5 cm in thickness, about 10 to 18 cm in length, and about 2.5 to 10 cm in height. In light of the extra mass of the glasses, keys, phones, etc., as compared to rings and/or hearing aids, in some embodiments, the size and/or configuration of the fasteners/fastener system will be adjusted accordingly to provide for secure mounting of the larger pouch. Similarly, in light of the extra mass of the glasses, keys, phones, etc., as compared to rings and/or hearing aids, in some embodiments, the size and/or configuration of the fasteners/fastener system used for securing the pouch opening will be adjusted accordingly to ensure retention of the deposited items. In some embodiments, the liner includes a brushed or extra soft finish to reduce the likelihood that the glasses will be scratched during placement and removal from the larger pouch.

Some embodiments of the ring pouch are configured using magnetic attachment elements to provide at least a portion of a fastener system. As will be appreciated, in some embodiments the actual magnetic component of a magnetic attachment element may be provided on only one portion of the element configured for engaging a ferrous surface (existing, e.g., medicine cabinet, or mounted as part of a fastener system. In other embodiments, there will be a plurality of magnetic components that are configured to provide magnet-to-magnet interaction to establish the desired attachments. In some embodiments, the magnetic attachment element may be used for mounting the message canvas, thereby allowing the breaking force of the pouch-to-message canvas attachment to be much lower than the breaking force of the pouch-to-mounting surface attachment.

It is therefore an object of one or more embodiments according to the present disclosure to provide a pouch that is affixed onto one area where needed, it is aesthetically pleasing to the outsider, convenient, and has easy accessibility. The body of the affixed open top pouch is made of material, that is bendable, lined with antimicrobial material and creates a convenient, accessible, and ‘smart’ solution.

Having a suitably size and configured pouch affixed in the same location everyday provided the consumers with a safe, consistent location to place their belongings, thereby allowing them to continue with tasks generally unsuitable in combination with the stored items. The consumer-selectable, fixed location, tends to increase the visibility and utilization the ring pouch, provides increased accessibility, and enables the consumer to save time, effort, and energy, while protecting their valuable and/or delicate items.

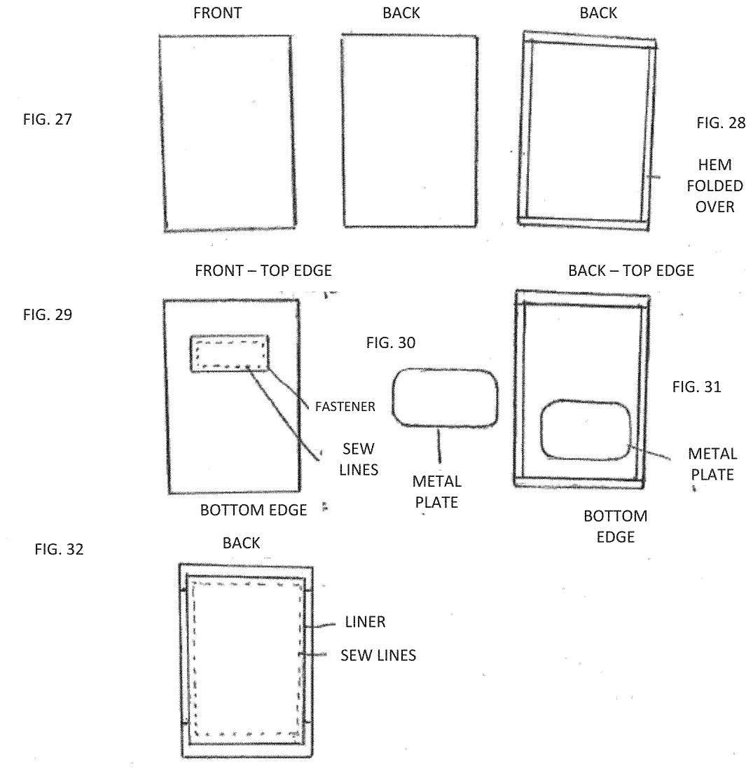

Some embodiments of the ring pouch include a main body made of first material, that is lined with a second antimicrobial material that can be sewn or otherwise attached onto the interior surfaces of ring pouch. Some embodiments of the ring pouch include some of the same basic ring pouch construction methods as detailed above with respect to the first and second embodiments. As shown in FIGS. 27-32, in some embodiments the Pieces 1 and 2 of the previous embodiments are incorporated into a single piece of material, FIG. 27, that is hemmed along its periphery, FIG. 28, to which a lining, FIG. 32 and front and rear fasteners and/or fastener systems, FIGS. 29-31, are attached to the exterior surface of the ring pouch. As shown in FIGS. 30-31, some embodiments include a ferrous metal plate as part of a surface mounting fastener system for use in combination with a message canvas fastener, e.g., hook and loop material, provided on a front surface of the ring pouch. The ferrous metal plate may be mounted to the exterior surface of the ring pouch using a suitable adhesive, additional stitching, or any other suitable means for securing the ferrous metal plate to the ring pouch.

In some embodiments a sealed magnet provided on a second portion of the surface mounting fastener system, FIG. 36, with an adhesive, an easily removable adhesive (e.g., Command™ or similar product), or another attachment means being provided on the opposite side of the second portion. Once the consumer has mounted the second portion of the surface mounting fastener system to is selected mounting surface, the magnet(s) is free to engage the ferrous metal plate and thereby form a magnetic attachment between the ring pouch and the mounting surface.

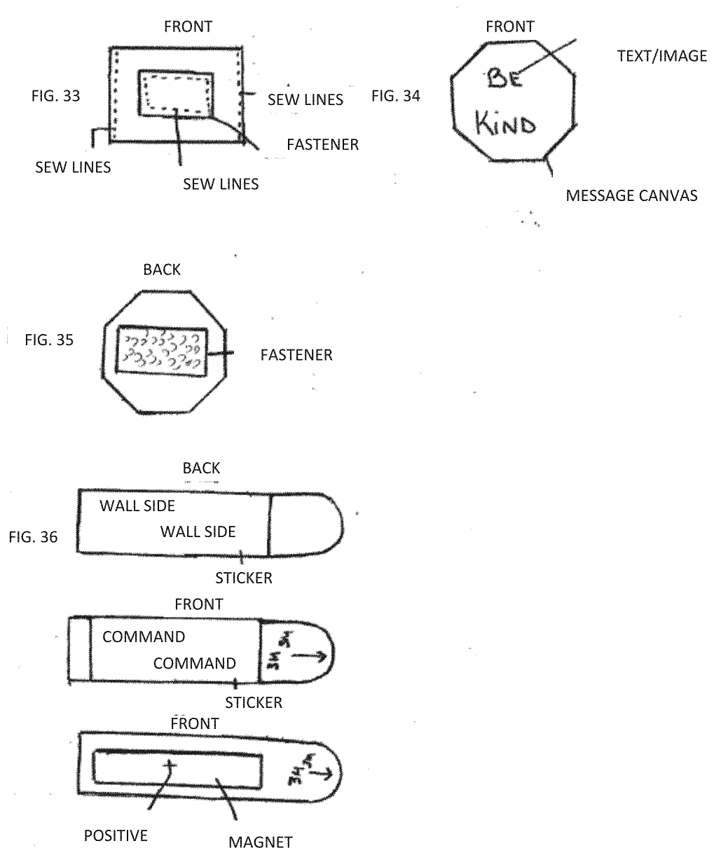

As detailed above, some embodiments of the ring pouch that utilize a magnetic mounting system can also be configured with a fastener configured for supporting a message canvas, FIG. 33, that the consumer can use to display word(s), saying(s), design(s), image(s), and/or other informative, ornamental, and/or decorative element(s) that are applied to the Front side of the message canvas, FIG. 34, using, for example, inks, dyes, paint, thread, floss, appliques, or any other suitable media using one or more techniques including, for example, painting, dyeing, silk screening, embroidery, stamping, and/or stenciling. As shown in FIG. 35, the Back side of the message canvas is provided with a portion of a fastening systems configured for engaging the front fastener as provided on the ring pouch.

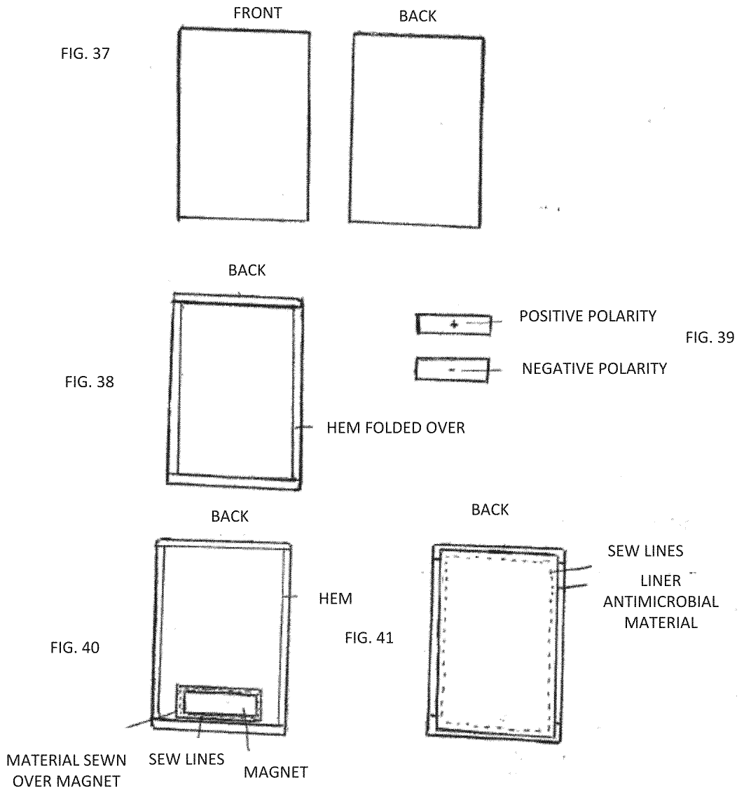

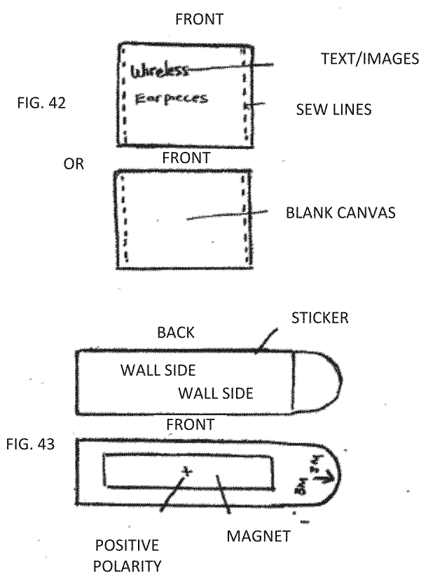

Some embodiments of the ring pouch include a modification of the magnetic mounting system discussed above. These embodiments, FIGS. 37-43, show the use of a pair of magnets, FIG. 39, having opposite polarity with one magnet being mounted on the back surface of the ring pouch, FIG. 40 and the other being affixed to the mounting surface, using, for example, the fastener shown in FIG. 43. As shown in FIG. 42, the message canvas can include prepared word(s), saying(s), design(s), image(s), and/or other informative, ornamental, and/or decorative element(s) or may be left blank for customization by the consumer.

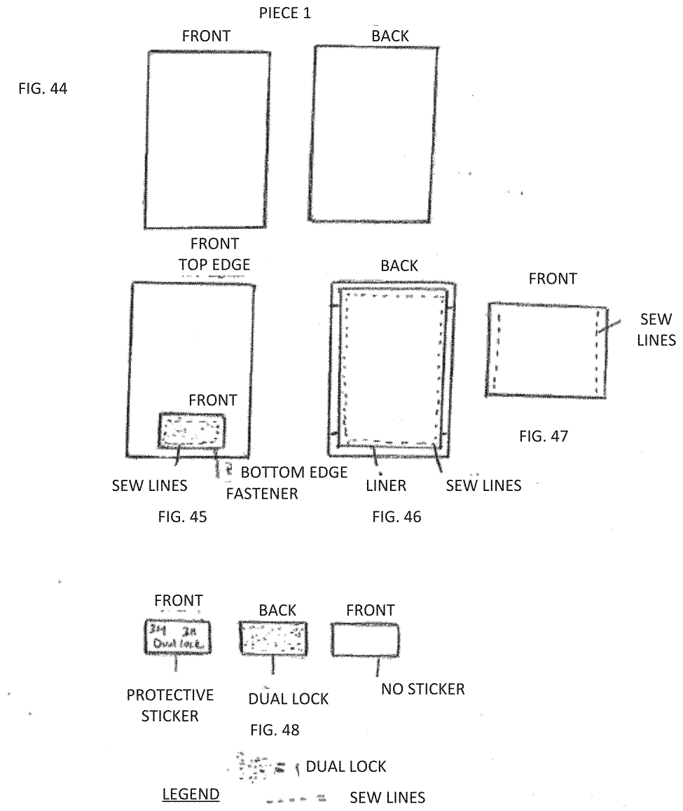

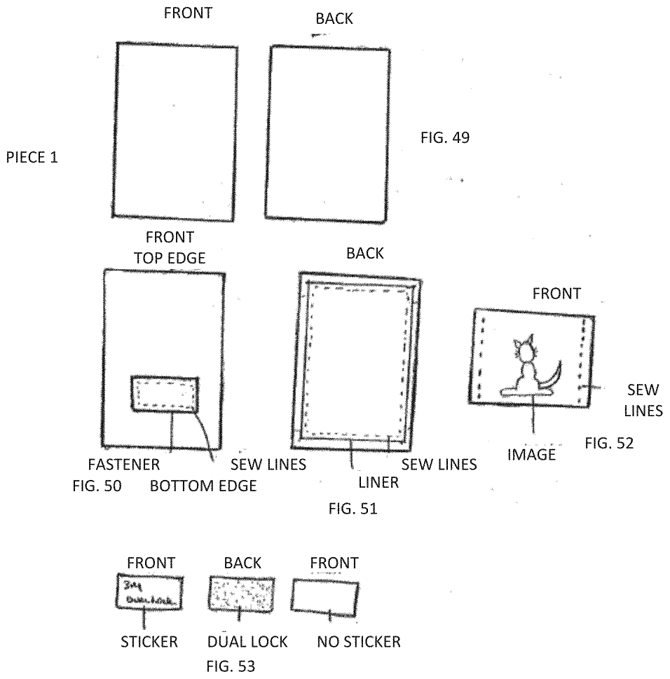

Some embodiments of the ring pouch include a modification of the magnetic mounting systems discussed above. These embodiments, FIGS. 44-56, show the use of a fastener system comprising two sheets of column and ball fastener material (e.g., Dual Lock™ fastener system) in place of the magnets, FIG. 53, with one portion of the column and ball material fastening system being mounted on the back surface of the ring pouch, FIG. 50 and the other portion of the column and ball material fastening material system being affixed to the mounting surface, using, for example, the fastener shown in FIG. 53. As shown in FIG. 52, the message canvas can include prepared word(s), saying(s), design(s), image(s), and/or other informative, ornamental, and/or decorative element(s) or may be left blank for customization by the consumer.

In some embodiments particularly suited for travel applications, a first portion of a fastener system is attached to a rear surface of the ring pouch and a second portion of the fastener system is attached to the mounting surface. In order to reduce or eliminate damage to the mounting surface, particularly with respect to potential mounting surfaces available in a hotel, offices, and/or residences in which the consumer is a guest, some embodiments incorporate a removable adhesive strip, e.g., a Command™ strip, either alone or in combination with another fastening means, e.g., a hook and loop fabric or strips of Dual Lock™ material whereby the ring pouch can be easily mounted, removed, and remounted in a different location without damaging the mounting surface.

For each of the embodiments that include a separate and removable message canvas, any word(s), saying(s), designs, and/or images provided on the message canvas can be changed by the consumer after purchasing another compatible message canvas, modifying a blank message canvas, and/or applying a new message surface over the original message surface, in order to better reflect the consumer's interests. In some embodiments, the front surface of the ring pouch can be utilized as the message canvas. Although such embodiments to not allow for an easy changeover of the message and/or imagery provided on a separate and easily detachable message canvas as detailed in connection with other embodiments.

The foregoing disclosure outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

I claim:

1. A pouch comprising:
first and second rectangular pieces of a first material attached to each other along at least a portion of at least three sides to form a first pouch having a first opening;
a first fastener attached to an outer surface of the first rectangular piece;
a second fastener attached to an outer surface of the second rectangular piece; and
a second pouch of a second material attached inside the first pouch and having a second opening, the second opening being aligned with at least a portion of an opening of the first pouch.

2. The pouch according to claim 1 wherein the first material differs from the second material.

3. The pouch according to claim 1 wherein the first material is a porous polymeric material.

4. The pouch according to claim 1 wherein the second material is an antimicrobial material.

5. The pouch according to claim 1 wherein the second material is a drywicking material.

6. The pouch according to claim 1 wherein the first and second rectangular pieces are first and second portions of a single unitary piece of the first material.

7. The pouch according to claim 1 wherein
the second pouch further comprises first and second fasteners arranged on opposite sides of the second opening, and
further wherein the first and second fasteners are configured for engagement sufficient to maintain the second opening in a closed position.

8. The pouch according to claim 1 further comprising a message canvas, the message canvas comprising a display surface and an attachment surface and a message fastener provided on the attachment surface, wherein the message fastener is configured for engaging the first fastener to form a removable attachment between the message canvas and the pouch.

9. The pouch according to claim 7 wherein the message canvas is heart shaped.

10. The pouch according to claim 7 wherein the display surface of the message canvas comprises at least one decorative element.

11. The pouch according to claim 1, wherein the first fastener and second fastener are independently selected from a group of closures consisting of two-sided adhesive strips, hook and loop materials, loop and hook fasteners, magnetic fasteners, plastic or metal clips, z-clips, snap fits, slide fits, screws, plastic locking strips, and combinations thereof.

12. A pouch storage system comprising:
first and second pieces of a first material having substantially identical shapes;
the first and second pieces of the first material being attached to each other along a portion of a peripheral region to form a first pouch having a first opening, wherein the first opening is operable between a default closed condition and an open position;
a first portion of a mounting fastener attached to an outer surface of the second piece; and
a second portion of a mounting fastener configured for attachment to a mounting surface.

13. The pouch storage system according to claim 12, further comprising:
an antimicrobial lining provided on a majority of interior surfaces of the first and second pieces of the first material.

14. The pouch storage system according to claim 13, wherein:
the first and second pieces of the first material are a polymeric material having a softening temperature above 100° C.; and
the antimicrobial lining is a polymeric material having a softening temperature above 100° C.

15. The pouch storage system according to claim 12, further comprising:
a drywicking lining provided on a majority of interior surfaces of the first and second pieces of the first material.

16. The pouch storage system according to claim 12, wherein the first and second portions of the mounting fastener are selected from a group of closures consisting of two-sided adhesive strips, hook and loop materials, loop and hook fasteners, magnetic fasteners, plastic or metal clips, z-clips, snap fits, slide fits, screws, and plastic locking strips.

17. The pouch storage system according to claim 12, further comprising:
a message canvas, the message canvas comprising
an ornamental display surface,
an attachment surface, and
a message fastener provided on the attachment surface,
wherein the message fastener is configured for engaging a surface fastener on an outer surface of the first piece of the first material to form a removable attachment between the message canvas and the pouch.

18. The pouch storage system according to claim 17, wherein a first engagement breaking force of the removable attachment between the message canvas and the pouch is less than a second engagement breaking force an attachment between the first and second portions of the mounting fastener.
